(19) United States
(12) Patent Application Publication
(10) Pub. No.: US 2016/0379469 A1
(43) Pub. Date: Dec. 29, 2016

(54) TIME-BASED VISUAL NOTIFICATION DEVICE AND METHODS OF USE THEREOF

(71) Applicant: Steridate, LLC, Rancho Santa Fe, CA (US)

(72) Inventors: Jason T. Flodin, Allentown, PA (US); Allen Newman, Rancho Santa Fe, CA (US)

(21) Appl. No.: 15/191,445

(22) Filed: Jun. 23, 2016

Related U.S. Application Data
(60) Provisional application No. 62/183,687, filed on Jun. 23, 2015.

(51) Int. Cl. G08B 21/24

(52) U.S. Cl. CPC G08B 21/24

(57) ABSTRACT

A time-based visual notification device (TND) provides visual, time-based notifications relating to a usability of an item via a visual indicator, power source and microcontroller programmed to track time intervals and illuminate the visual indicator with particular colors or patterns of illuminations to provide customized visual indications of the time intervals. The TND may be embodied as a sticker or tag, embedded within packaging, labels, storage containers, or even integrated within a product such as a medical device. The time intervals may be customized for a particular item, device or application and may either be pre-programmed for a desired time interval or customized to a desired time interval at the time of activation. A dispensing mechanism may be provided with a housing which contains a plurality of TNDs connected in sequence and a dispensing activator to activate each TND as it is removed from the dispensing mechanism.

### BACKGROUND

Field of the Invention

Devices and methods provided herein relate to a time-based notification device, and more specifically to a time-based visual notification device and dispensing activation mechanism for providing time-interval notifications in time-sensitive applications such as sterilizations, medications, perishable products and the like.

Related Art

Tracking time intervals and elapsed time for various products and equipment is critical in numerous industries. In a healthcare setting, medical equipment must be sterilized or disinfected to prevent cross-contamination from one use to another. However, in many cases the medical equipment is only guaranteed to be sterile or infection-free for a certain period of time after a sterilization or disinfection process has been completed. To determine whether certain equipment has passed an accepted sterilization/disinfection window requires an onerous amount of record keeping for tracking and monitoring equipment. Different types of equipment with different windows only adds to the complexity of labeling and identifying whether equipment is safe for use or when a device or product is nearing an end of its usability window.

The complexity of labeling requirements increases the risks of mistakes. A medical professional will still have a difficult time determining whether the equipment is still usable due to the complexity of a label or the fact that the expiration date may still need to be determined.

Other products also require careful monitoring of time. In addition to medical equipment and devices, medications, industrial and manufacturing compounds such as resins and reagents, and other biologics have varying expiration dates that also require meticulous labeling and verification prior to use. In the food industry, food safety is an ever-increasing priority as food-borne illnesses have devastating effects on consumers and the companies implicated in a food-related contamination outbreak. The food industry spends a significant amount of effort to provide expiration dates on food products, but many products which are susceptible to spoiling remain unmarked due to the nature of the product, the packaging or the method in which a consumer stores the product at home.

There is therefore a great need to accurately and easily label and identify equipment, medicine, food and other products with time-based information.

### SUMMARY

A time-based visual notification device is described herein which can be affixed to, placed by or embedded within an item to provide a visual notification of a usability of the item based on an elapsed time. The visual notification may be provided by a visual indicator such as a light-emitting diode (LED) connected to a microcontroller and power source which are programmed to provide various colors or patterns of illumination corresponding to particular time intervals. The time-based visual notification device, or TND, may be embodied as a sticker or tag, embedded within packaging, labels, storage containers, or even integrated within a product such as a medical device. The time intervals may be customized for a particular item, device or application and may either be pre-programmed for a desired time interval or customized to a desired time interval at the time of activation. A TND surface may further include printed information on the activation date or time-based notifications of the device which may be impressed upon the device. A dispensing mechanism may be provided with a housing which contains a plurality of TNDs connected in sequence and a dispensing activator to activate each TND as it is removed from the dispensing mechanism.

In one embodiment, a time-based visual notification device comprises: a housing forming at least a top surface and a bottom surface and defining an interior space; a power source positioned within the interior space; a visual indicator connected with the power source and positioned within the top surface which displays one or more visual indications; a controller connected with the power source and the visual indicator which activates the visual indicator to display a first visual indication at a specified time interval of a limited period of time; and an affixing mechanism attached with a portion of the housing which affixes the time-based visual notification device to an item.

In another embodiment, a method of monitoring a usability of an item, comprising the steps of: activating a time-based visual notification device to begin measuring a first time interval of a limited period of time; displaying a first visual indication of the specified time interval during the limited period of time; affixing the time-based visual notification device to the item; and displaying a second visual indication at a second specified time interval upon expiration of the limited period of time.

In a further embodiment, dispenser for a time-based visual notification device, comprising: a housing configured to contain a plurality of time-based visual notification device; and a dispensing mechanism which dispenses at least one time-based visual notification device from the housing at a time; and an activation mechanism which activates the time-based visual notification device to begin measuring at least one time interval as the visual notification sticker is being dispensed.

A medical device, comprising: a housing defining an interior space within the medical device; a power source positioned within the interior space; a visual indicator which displays one or more visual indications and which is connected with the power source, wherein the visual indicator is positioned within the housing so as to be visible on an exterior surface of the medical device; a controller connected with the power source and the visual indicator which activates the visual indicator to display a first visual indication at a specified time interval of a limited period of time; and an activation mechanism located on the exterior surface of the medical device which activates the controller to begin measuring the limited period of time and activate the visual indicator at the specified time intervals within the limited period of time.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is an illustration of a time-based visual notification sticker, according to an embodiment of the invention;

FIG. 2 is an illustration of an interior circuitry of the time-based visual notification sticker of FIG. 1, according to an embodiment of the invention;

FIG. 3 is an illustration of a time-based visual notification tag, according to an embodiment of the invention;

FIG. 4 is an exploded-view illustration of an interior of the time-based visual notification tag, according to an embodiment of the invention;

FIG. 5A is a block diagram illustration of an internal electrical configuration of a time-based visual notification device (TND) with a light emitting diode (LED) visual indicator, according to an embodiment of the invention;

FIG. 5B is a block diagram illustration of an internal electrical configuration of the TND with an electronic ink visual indicator and liquid crystal display (LCD), according to an embodiment of the invention;

FIG. 6 is an illustration of a time-based visual notification sticker affixed to an item, according to an embodiment of the invention;

FIGS. 7A and 7B are illustrations of a TND integrated within a medical device, according to an embodiment of the invention;

FIG. 8A is an illustration of a pull-tab dispenser for dispensing TNDs, according to an embodiment of the invention;

FIG. 8B is an illustration of a group of color-coded pull-tab dispensers for dispensing visual notification stickers with differing time-intervals, according to an embodiment of the invention;

FIG. 9 is an illustration of a series of connected time-based visual notification stickers used in the pull-tab dispenser, according to an embodiment of the invention;

FIG. 10 is an illustration of a dispenser for dispensing the time-based visual notification tags, according to one embodiment of the invention;

FIGS. 11A and 11B are illustrations of a method of activating a TND using a plastic separator, according to an embodiment of the invention;

FIG. 12 is an illustration of a method of activating a TND using a radio frequency remote activator, according to an embodiment of the invention;

FIG. 13 is an illustration of a method of activating a TND using a conductive tape, according to an embodiment of the invention;

FIG. 14 is an illustration of a pattern of color illumination for a visual notification sticker with two visual indicators, according to an embodiment of the invention;

FIG. 15A and FIG. 15B are illustrations of patterns of displays on an e-ink display of the visual notification sticker, according to an embodiment of the invention;

FIG. 16 is a flow diagram of a method of monitoring a time interval using the visual notification sticker, according to an embodiment of the invention;

FIG. 17 is a flow diagram of a method of activating and measuring a time interval using the visual notification sticker, according to an embodiment of the invention; and

FIG. 18 is a block diagram illustrating an example wired or wireless processor enabled device that may be used in connection with various embodiments described herein.

### DETAILED DESCRIPTION

Embodiments described herein provide for a time-based visual notification device (TND) which can be affixed to, placed by or embedded within an item to provide a visual notification of a usability of the item based on an elapsed time, wherein the TND comprises a visual indicator such as a light-emitting diode (LED), a power source and a microcontroller programmed to measure time intervals and illuminate the visual indicator with particular colors or patterns of illuminations to provide visual indications of time related to the usability of an item. The TND may be embodied as a sticker or tag, embedded within packaging, labels, storage containers, or even integrated within a product such as a medical device. The time intervals may be customized for a particular item, device or application and may either be pre-programmed for a desired time interval or customized to a desired time interval at the time of activation. A TND surface may further include printed information on the activation date or time-based notifications of the device which may be impressed upon the device. An activation mechanism may also be provided on the sticker to activate the sticker to begin tracking and displaying time-based indicators, and the activation mechanism may be activated by a dispensing mechanism in a dispenser which stores one or more stickers until they are needed.

The TND may be utilized to provide a simple, inexpensive yet highly accurate visual indication of the usability of an item, whether the item is a disinfected or sterilized piece of medical equipment, medication, food, perishable product or any item with time-based usability. The usability may therefore represent the life span, cleanliness, or quality of the item. When in compliant operation, the visual indicator provides a specific color or flash pattern to indicate compliance, and in contrast provides a distinctly different color or flash pattern to indicate a lack of compliance in a non-compliant operation. There are numerous potential forms and applications that the TND may take, non-limiting examples of which include being affixed to the item in the form of a sticker, placed adjacent to the item in the form of a tag or hook, integrated into an item's packaging or storage container, or integrated into the item itself.

In one embodiment, a TND sticker as described herein provides a simple, fast and effective indication of sterility and a time interval that has elapsed since a sterilization process has been performed. The TND sticker is flat and flexible and able to be attached to basically any type of product or item. The TND is able to provide a variety of time interval indications via a simple visual indicator to meet various guidelines for sterilization and reprocessing, such as those of high level disinfection (HLD). The sticker can be affixed to any number of devices or packages through various adhesion options to make it useful for medical devices, surgical equipment, instruments, medications, food products or any type of packaging. Additionally, it can be manufactured to be disposable after a single use or reusable and reprogrammable, providing flexibility for any type of application and cost. Specialized dispensers may be provided to activate the stickers as they are dispensed and label each sticker with activation data and other information useful for tracking and analytics.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

Sticker Design and Form Factor

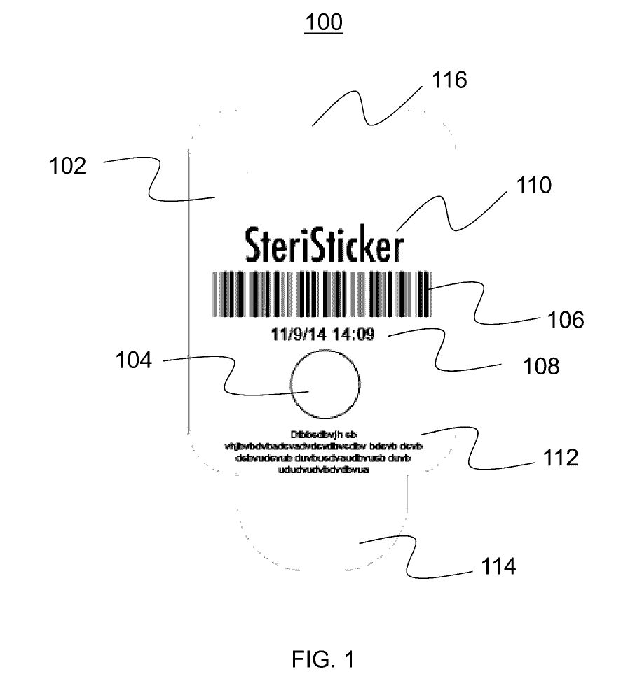

One embodiment of the time-based visual notification device (TND) is a TND sticker, as illustrated in the top-down illustration in FIG. 1. The TND sticker 100 has a housing which includes a top surface 102 with at least one visual indicator 104 which provides a form of visual notification that can be easily perceived by a user. In one embodiment, the visual indicator 104 may be surrounded by a foil ring reflector (not shown) to amplify the indicator. The TND sticker 100 illustrated here also includes printed tracking data, such as a barcode 106 and date stamp 108, which can be used to provide additional information about the TND or the item to which it is affixed. Additional printed indicia, such as branding 110 and instructions 112, may also be provided on the top surface 102.

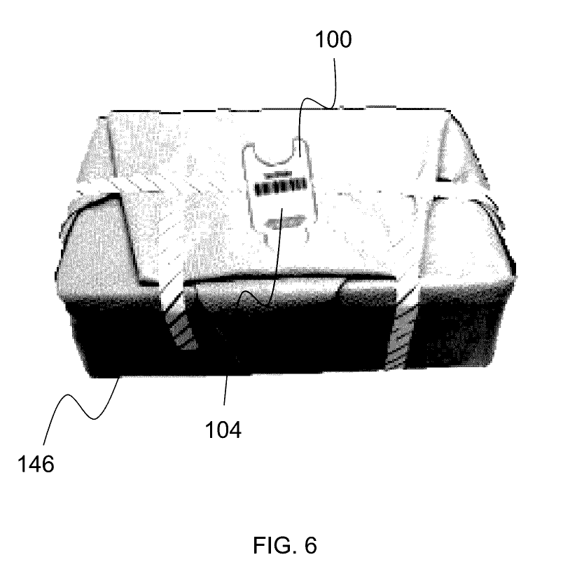

In this embodiment, the TND sticker has a general shape similar to a pull-tab with a tab 114 provided on a first end of the sticker 100 to allow the sticker 100 to be pulled and dispensed from a roll of connected stickers, as illustrated and described in further detail below. A second end of the sticker 100 has a corresponding indentation 116 where a tab 114 of a connected sticker on the roll would be attached. Although not illustrated, the bottom surface of the sticker 100 will include an affixing mechanism—such as an adhesive—to affix the sticker to an item or object, as illustrated in FIG. 6.

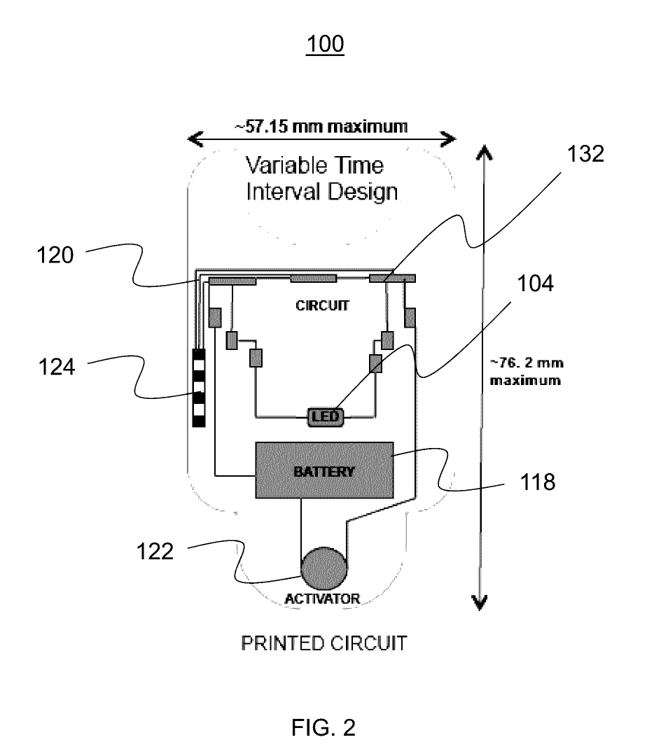

FIG. 2 illustrates an inner portion of the sticker 100 which may be positioned between the top surface 102 and bottom surface which forms the housing, wherein each surface represents a layer of material which substantially encloses the inner portion. The inner portion may include a power source 118 such as a battery and a connected circuit 120 which are thus connected to the visual indicator 104 like a light emitting diode (LED). Other forms of visual indicators will be discussed in detail below. The power source 118 powers the visual indicator 104, while the circuit 120 connects the power source 118, microcontroller 132, activator 122 and other connected sensors 124 with the visual indicator 104. The microcontroller 132 may also be positioned in the inner portion of the sticker to measure time and control the illumination of the visual indicator 104 based on programmed interval measurements or thresholds of elapsed time. The microcontroller 132 may be a small integrated computer. The activator 122 may be located on the pull-tab portion 114 of the sticker 100 to activate or initiate the measurement of time and display of a visual indicator when the sticker is ready to be used.

Although only illustrative of one embodiment, the TND sticker 100 may have a size of approximately 57 millimeters in length and 76 millimeters in height, such that it can be easily grasped by a user and viewed from a distance. In an alternate embodiment, the dimensions may be approximately 3 inches in height and approximately 2.25″ wide. The materials of the TND may be food-safe materials.

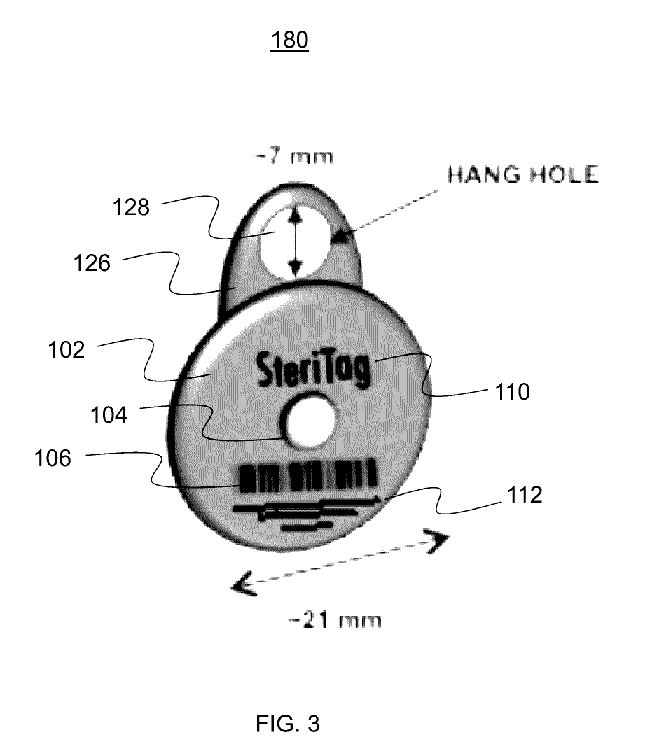

FIG. 3 illustrates another embodiment of the TND in the form of a TND tag 180 which has a hang hole extension 126 extending from one portion of the TND tag with a hang hole 128 for hanging the TND tag with or immediately adjacent to an item. The TND tag 180 includes the visual indicator 104, bar code 106, branding 110 and instructions 112 similarly to the TND sticker 100. However, the TND tag 180 may not require an adhesive bottom surface if it is simply being hung with the item. In this embodiment, the TND tag has a generally circular shape with a maximum width (or circumference) of approximately 21 millimeters and a hang hole extension width of approximately 7 millimeters, although these dimensions may be altered depending on the application for which they are needed.

The tag may be affixed to the item through several different methods, such as by magnet, clip or strap. The tag may be more durable than the sticker if it is intended to be reused or more permanently affixed than the sticker. For example, the tag may be rubberized or otherwise encapsulated in a protective coating and would therefore be easier to remain sterile and be capable of reuse or use in environments which require a more durable material or adhesion method. Activation of the tag may be accomplished by depressing a center of the tag.

In a further embodiment, the tag may be integrated into a device, product, instrument, container, packaging or other object or item, such as a product label, packaging or wrapping, storage device, container housing, bag, etc. The tag may be integrated during the manufacturing or production process to provide an accurate, visible measure of elapsed time starting from a manufacturing or shipping date.

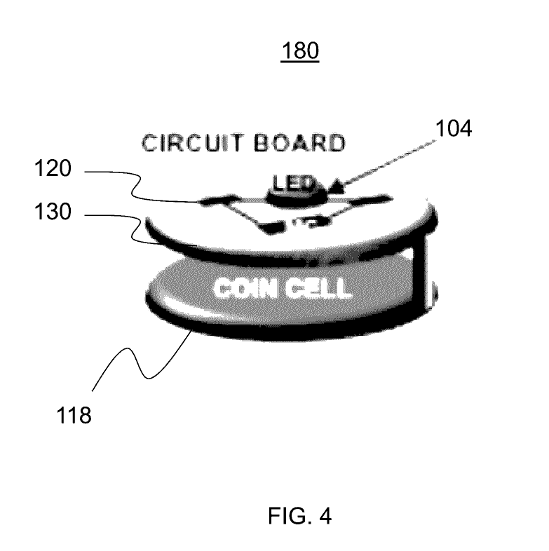

FIG. 4 illustrates a perspective exploded-view of the TND tag 180 from FIG. 3, further illustrating the position of a circuit board 130 and an adjacent coin cell battery 118 which is connected with the circuit board 130 for supplying power thereto. In this embodiment, the battery 118 may be a circular coin cell battery which is positioned immediately behind/below the similarly-shaped circuit board 130 to simplify the construction and assembly of the TND tag 180. In this embodiment, a user will simply press a center portion of the tag 180 in order to cause the device to activate.

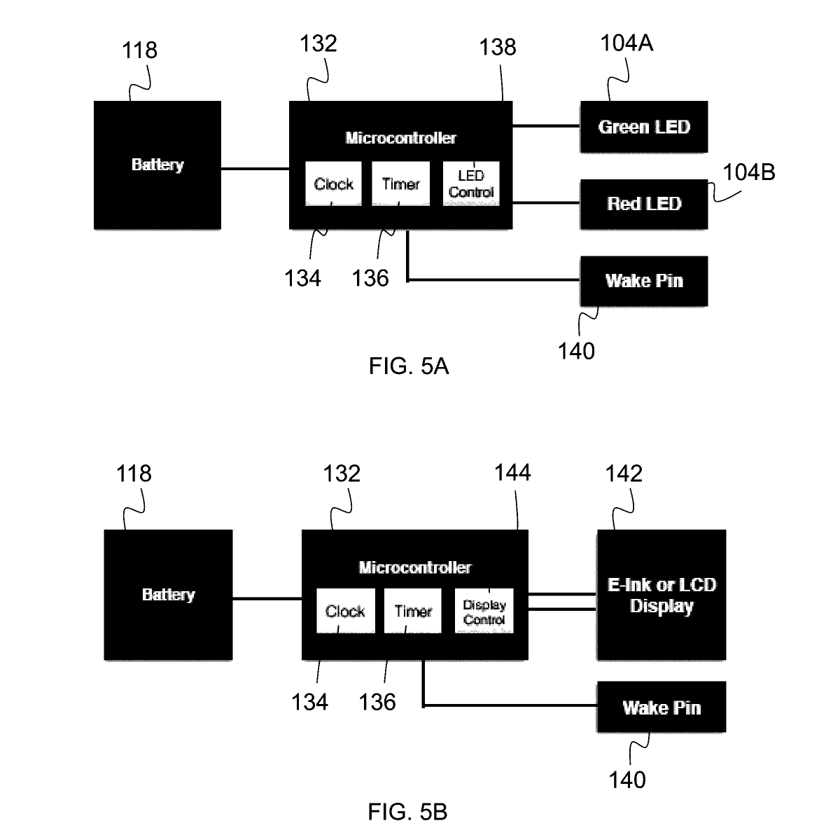

To more clearly describe the electronics and control mechanisms for the TND, FIG. 5A and FIG. 5B illustrate block diagrams of the internal electronics of differing embodiments of the TND. As shown in a first embodiment in FIG. 5A, a microcontroller 132 is connected with the battery 118 and also with one or more visual indicators, such as a green LED 104A and red LED 104B. The microcontroller 132 contains a clock module 134 for keeping time, a timer module 136 for measuring programmed time intervals, and an LED control module 138 for controlling the illumination of the LEDs in response to the measured time intervals. A wake pin 140 provides for remote activation of the TND, as will be described further below. FIG. 5B illustrates an alternative configuration where instead of the LED visual indicators, an e-ink or LCD display 142 is provided, and as a result, the microcontroller contains a display control module 144 for controlling the content of the display 142.

In one embodiment, the TND sticker may be made from a thin plastic or paper material which has its top surface and bottom surface bonded together around the edge of each surface to enclose the electronics within. The bottom surface may include a removable covering which protects an adhesive material until the user is ready to affix the bottom surface of the sticker to an item. Other types of adhesion methods may be utilized, such as magnetic, friction, static, Velcro®, clips, tabs, loops, etc. The material may be food-safe or medical-grade material depending on the application.

FIG. 6 illustrates one embodiment of an application for a TND sticker 100, where it is affixed to medical equipment packaging 146 which contains disinfected or sterilized medical equipment. The sticker 100 may be affixed to the packaging of the medical equipment 100 so that a user can easily see the sticker 100 and the visual indicator 104 in order to determine whether the medical equipment is still considered sterile. The TND sticker may simply be affixed to the packaging 146 or it could be used to seal the packaging and indicate that the enclosed medical equipment has not been tampered with or opened. To more accurately determine if the TND seal has been broken, the TND may include additional position, motion or other sensors which may cause the visual indicator to change from a valid indication to an invalid indication to reflect potential tampering. In a related embodiment, the TND may instead be incorporated into the packaging itself.

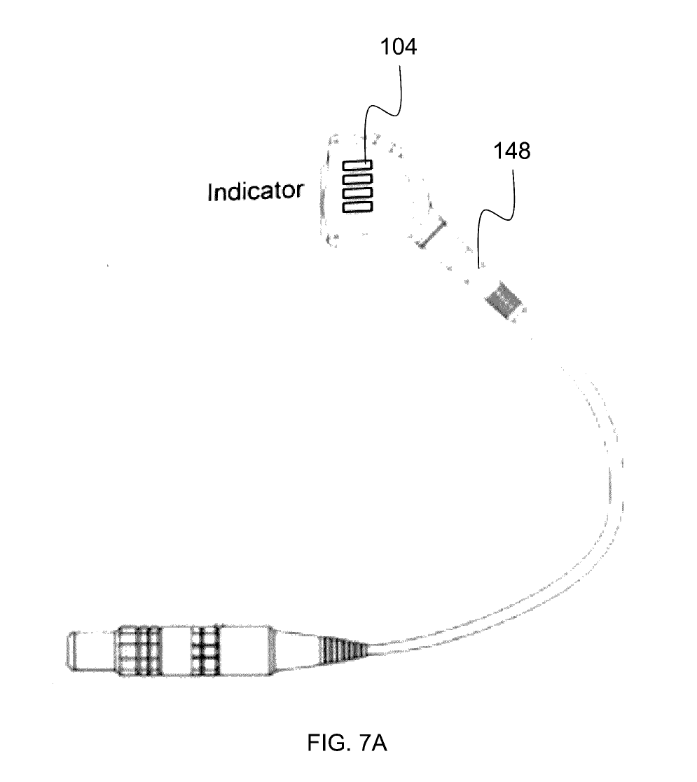

FIG. 7A illustrates another embodiment where the TND is integrated into a medical device 148 such that the only external portion of the TND is the visual indicator 104. FIG. 7B illustrates a similar embodiment of a medical device 148 with an integrated TND with only the visual indicator 104 visible on a side wall of the medical device. In the integrated embodiment, the TND may be reset each time the medical device is cleaned.

Additionally, an integrated TND may be tied into additional sensors on the medical device in order to provide additional metrics relating to the usability of the medical device, such as a thermal sensor which measures a temperature-dependent factor of usability in conjunction with a time-dependent factor to provide an indication of usability based on both time and temperature (i.e. for sterilization applications). In one application, the TND may not activate the time-interval measurement until a threshold temperature is reached, for example to measure spoilage of food. This combination of other sensors and metrics could potentially be useful in other non-integrated applications where additional sensors are integrated into the TND itself, for example to measure temperature, humidity, light, air pressure, radiation or other particulates or contaminants. In one example, the time-intervals may coincide with temperature measurements that provide periodic temperature checks at certain time intervals in order to ensure that an item is maintained within an environment at a desired temperature.

In a further embodiment, the TND may be integrated into a shelf or cabinet for storing items whose time-dependent usability needs to be measured. The TND may be embodied as a tray for holding an item, or integrated within a shelf unit for storing an item and have an activation button, switch, etc. to activate the TND when an item is placed thereon. Additionally, the TND may be developed as a hook on which an item may be hung, and may even have a motion sensor which activates the TND when an item is placed on the hook. In each of these integrated embodiments, the visual indicator may be located so as to be clearly visible to a user viewing the cabinet, shelf or hook, even if the visual indicator is located remotely from the TND itself. For example, where the TND is integrated into a hook, the visual indicator may be positioned on a front of a shelf above or below the hook so it can be more easily visible to a user.

The embodiments described heretofore refer to the inventive apparatus as a sticker which can be affixed to an item or object to provide a visual display of a time interval or period of elapsed time. The TND sticker is easy to manufacture and designed as a single use disposable sticker. Although primarily described herein as a sticker, other form factors may be utilized to allow for different affixing mechanisms or better integration with the item or object, such as the previously-described tag.

Dispenser

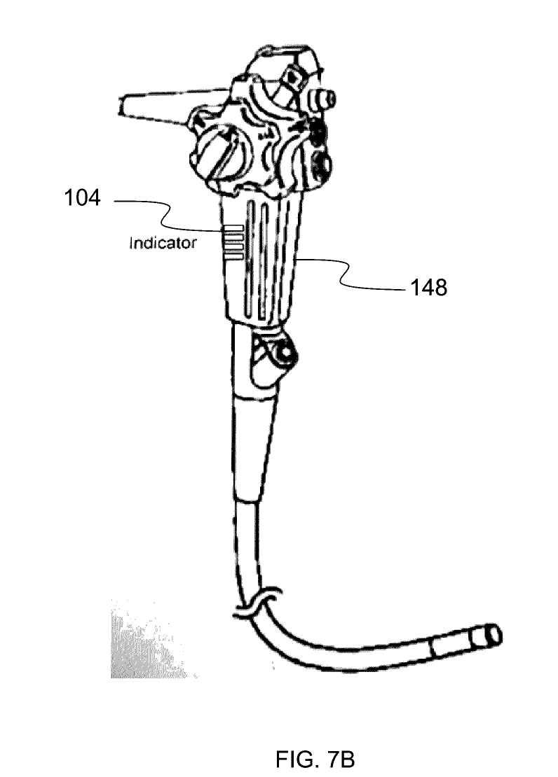

In one embodiment, a dispenser 150 may be provided to store, dispense and activate TNDs, as illustrated in FIG. 8A. The dispenser may hold a plurality of TNDs arranged in any method feasible, such as the pull-tab stickers of FIG. 1, a pop-up dispenser, or a single use dispenser or packaging which holds only a single sticker. In this embodiment, the dispenser 150 is configured to store and dispense pull-tab TND stickers such as that shown in FIG. 1, where a single TND sticker 100 partially protrudes from a dispensing area 152. When a TND sticker is to be dispensed, a user pulls on the tab portion 114 of the TND sticker 100, which acts to depress the activator 122 and activate the TND sticker 100.

In one embodiment, the dispenser 150 may be configured to dispense TND stickers with a pre-programmed time-interval measurement and be labeled or provided with a unique color to indicate the time interval the TND sticker is programmed to measure. For example, FIG. 8B illustrates a set of dispensers 150A, 150B, 150C and 150D which are each of a different color and each loaded with TND stickers designed to measure different time intervals. A user can therefore pull out a TND sticker from the appropriate dispenser which matches the time interval needed to be measured for a particular application. The TND stickers can also have the matching color of their dispensers to help users identify a particular color with a particular time interval of measurement.

In another embodiment, the dispenser may include a printing device, such as a thermal printer, to encode each sticker with the date stamp and barcode as each sticker is being dispensed. The barcode, date stamp or other information printed onto the TND sticker or TND device may provide additional information for tracking and linking to other records.

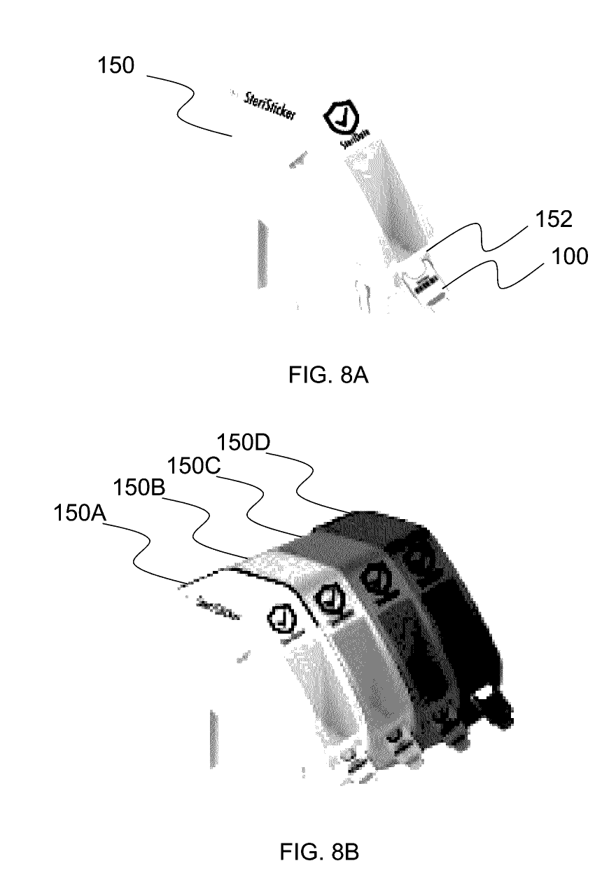

FIG. 9 illustrates a series of TND pull-tab stickers 154 which are initially connected with each other in an end-to-end configuration such that a tab portion 116 of each sticker 100 is partially attached with the recessed portion 114 of an adjacent sticker 100. The series 120 of pull-tab stickers may be stored in a roll and used in the dispenser 150. Other embodiments of cartridges or dispensers may be used which auto-advance a new sticker each time a sticker is dispensed by the user. In this particular embodiment, a user pulling and removing a sticker 100 from an end of a series of stickers will also activate the sticker 100 by putting pressure on the activation mechanism 122 as the sticker is being removed.

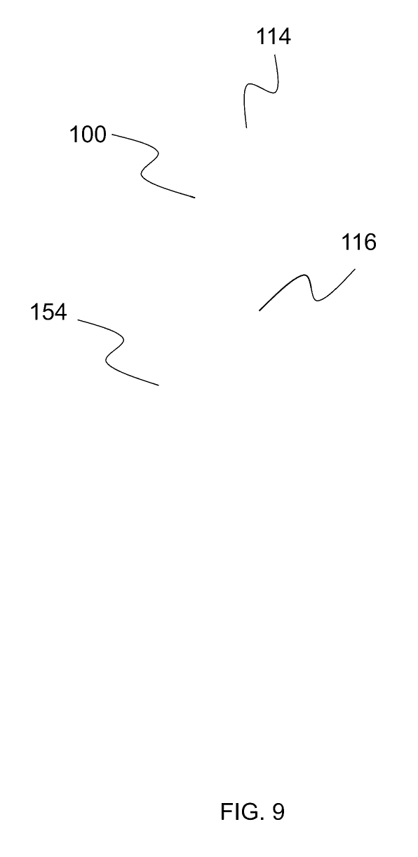

FIG. 10 is an illustration of a tag dispenser 156 for dispensing the TND tags 180 shown in FIG. 3. In this embodiment, the TND tags 180 may be stored in a stacked configuration within a cylindrical-shaped dispenser 156 and dispensed by pulling on the hang hole extension 126.

Activation

As has been described above, the TND may utilize an activator to begin the process of measuring a time interval so that the TND can be activated as needed by the user. Additionally, requiring activation before use will preserve a battery or whatever other power source is utilized to power the TND for as long as possible. In one embodiment, a mechanical activator is used, such as a membrane switch which can be crushed or pinched. In another embodiment, an electronic activator may be used, such as a digital, analog or radio frequency activator.

For the pull-tab TND sticker and dispenser illustrated herein, the placement of a mechanical activator in the pull tab 116 of the sticker provides for instantaneous activation as the user pulls a sticker from a dispenser.

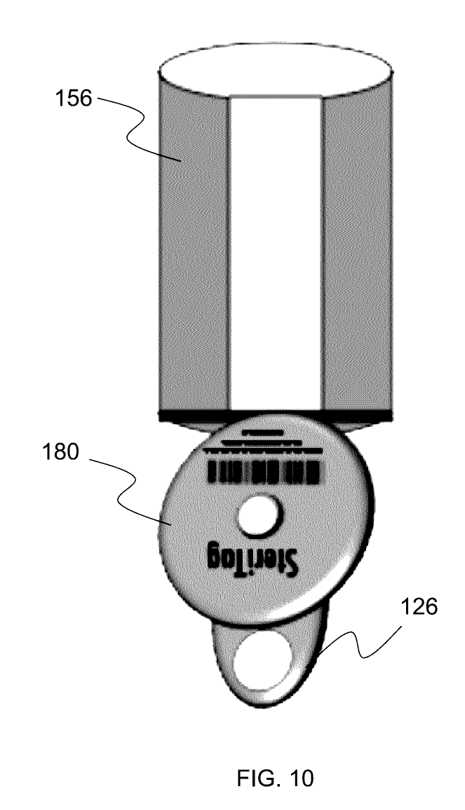

FIG. 11A illustrates a pull-tab activation method where a plastic tab 158 is positioned between the battery 118 and the circuitry 120, such that once the plastic tab 158 is pulled and removed, a spring contact 160 connects the battery and circuitry, as illustrated in the connected/activated embodiment in FIG. 11B. However, this requires manual activation by the user.

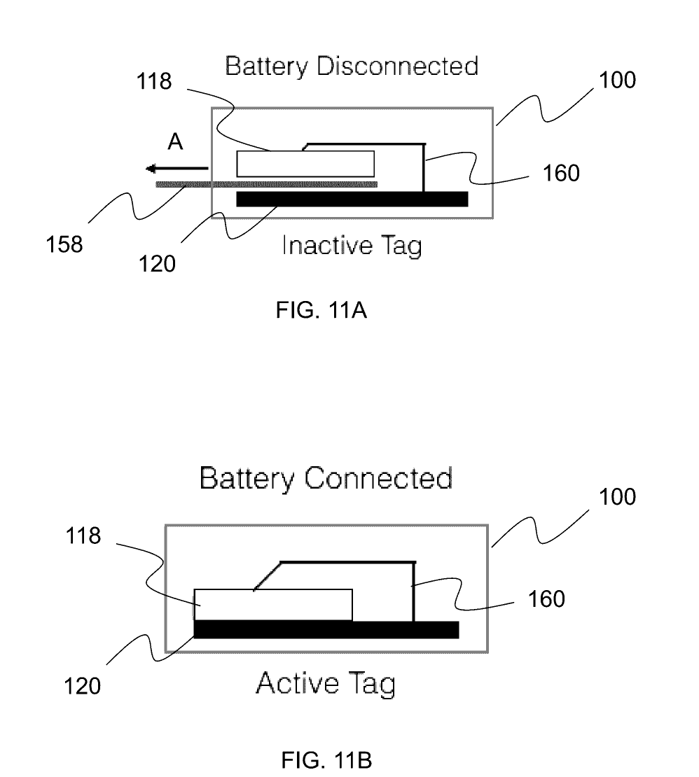

FIG. 12 illustrates a method of radio frequency activation of the TND, wherein the microcontroller is shut down until a wake pin is activated (as illustrated in FIG. 5A and 5B). The wake pin is connected to an RF receiver, and an external transmitter 162 is then placed close to the TND and transmits a signal when it is time to activate the TND. As shown in FIG. 12, an inactive TND 100A is moved in the direction of the tag activator 162, during which the TND 100B is activated. The result is the activated TND 100C. In one embodiment, a separate activation tool 162 may be utilized to activate the TNDs in this manner, or the activation transmitter may be built into the dispenser 150.

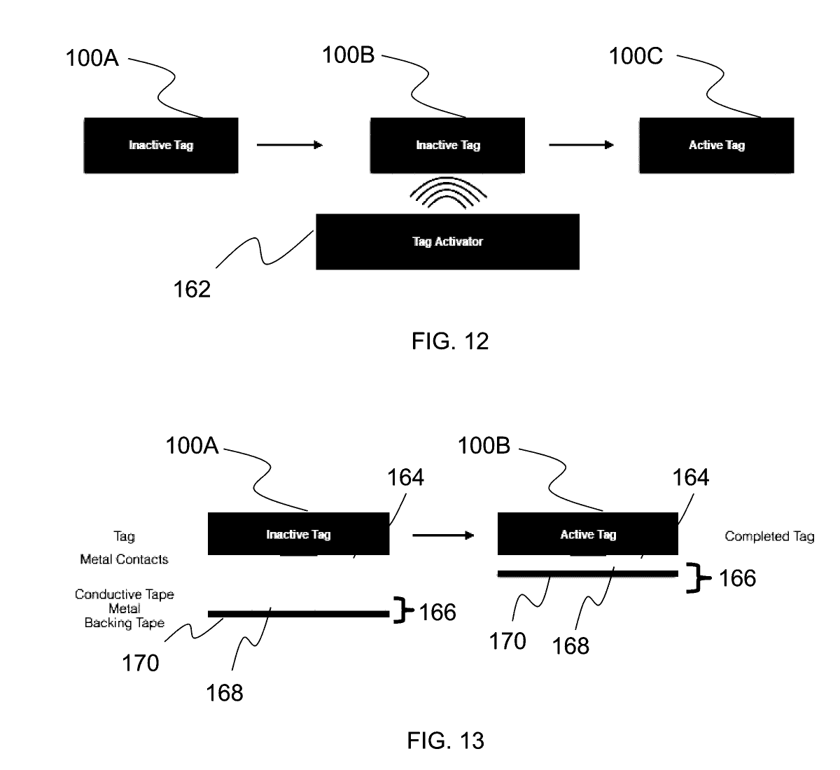

FIG. 13 illustrates a method of mechanical activation of the TND via the dispenser, where the dispenser completes a final mechanical processing step. In this embodiment, the inactive TND 100A is made with exposed metal contacts 164 on a bottom surface that require connecting with a corresponding conductive metal backing 166 material to connect the battery and create an activated tag 100B. In this embodiment, the dispenser provides this metal backing 166 in the form of segments of metal with conductive tape 168 on one side and a non-conductive tape 170 on the other, such that the dispenser laminates the metal backing 166 to the TND 100, thereby connecting the battery and completing the activation of the sticker.

Circuit Design

The electrical component of the TND device, primarily the circuit, may be a flexible circuit configured with a flexible, non-ridged substrate such as paper, polymer or conductive substrates such as metalized films and thin film metals such as aluminum, tin and alloys, or hybrid materials which may be composed of several distinct materials. The conductive elements of the flexible circuit may have various methods of deposition or application to the flexible substrate, including printing, screening, etching, deposition, evaporation, polymerization, curing with photo, light or heat, or other methods known to one of ordinary skill in the art. The conductive elements may include electrically conductive elements or particles on the order of 10⁻³ m to 10⁻¹⁰ m.

In one embodiment, a ridged circuit is used. The ridged circuit is a non-flexible element that is designed such that its shape and size allows for the application of the design of the sticker in any form factor described herein.

In a further embodiment, the circuitry may be printed or incorporated directly onto or into a battery or power source.

Interval Selection

Each TND is configured to measure one or more time intervals or an elapsed time and then provide a unique visual notification indicative of the measured interval or elapsed time. In one embodiment, a specific interval time is fixed for a particular TND by a predetermined electronic clock chip, which is a component of the circuit and integrated into each TND.

For example, in order to meet the requirements of high level disinfection (HLD), a TND sticker would need to be programmed for a specific time interval, such that the visual indicator provides a certain color or pattern of illumination prior to the expiration of the specified time interval and a different color or pattern of illumination once the specified time interval has expired. Other TND stickers may be programmed with varying time intervals that are application specific, and each sticker may be color coded to correspond to a certain time interval so that the user can easily identify the sticker required for a certain time interval.

In one example using a single LED as the visual indicator, active blinking illumination every 5 seconds corresponds to 80% of remaining cycle life of a product, and illumination every 2 seconds corresponds to 20% of remaining cycle life of the product. For a product with a life cycle of 5 days, the LED will illuminate every 5 seconds for the first 4 days and then every 2 seconds for the last day before expiration. When the cycle life has expired, illumination ceases altogether.

In another embodiment, a variable interval time is selected and encoded onto the clock chip, such that different intervals over different periods of time may be measured and indicated via the visual indicator. Thus, any interval or elapsed time may be easily and effectively measured and then displayed to the user via the visual indicator.

Visual Indicator

Although the visual indicator is commonly referred to herein as an LED, other light sources may be utilized, such as an organic light emitting diode (OLED), quantum dot nanocrystals, phosphorescents, chemical, electrochemical, electrophoretic, or other illumination technologies not yet developed. The visual indicator may also be an LCD or e-ink display, which can provide complex visual indications while maintaining the lower power requirements needed for such a device. For example, if a TND fails, a “failed” or “negative” status may be displayed on the screen.

At a basic level, the visual indicator need only provide a basic single illumination to indicate whether an item is or is not within a specified time parameter. As such, chemical or phosphorescent technology is applicable and advantageous for its simplicity. However, for more complex applications where various time intervals must be measured, or where various sequential or combined intervals of time require different types of visual notifications, a visual indicator such as an LED is advantageous for its ability to provide visual indications in the form of varying colors or patterns of light. The LED may flash briefly and maintain a low impact on battery life. For example, a CR1616 coin cell battery with a 55 mAh capacity may provide up to a one-month lifetime for a TND. For applications where a visual message is preferred and where a reusable or integrated tag is used, an e-ink or LCD display can be used. An e-ink display utilizes no power to maintain the display, and requires power only to change the image. The e-ink display is thin and semi-flexible.

Indicator Display Notifications

As described briefly above, varying types of visual notifications may be provided to indicate a variety of different time intervals or amounts of elapsed time. The types of visual notifications may include blinking, glowing, colors, illumination versus non-illumination and display of an icon, symbol or message. These may indicate that the item is or is not within time dependent limits and therefore whether the item is or is not a usable product.

In one embodiment, the absence of active illumination may also indicate that an interval time has ended or that the TND is no longer capable of measuring the time period corresponding to the item. Similarly, a failure in the sticker would not pose a risk of providing a false indication of validity of the item.

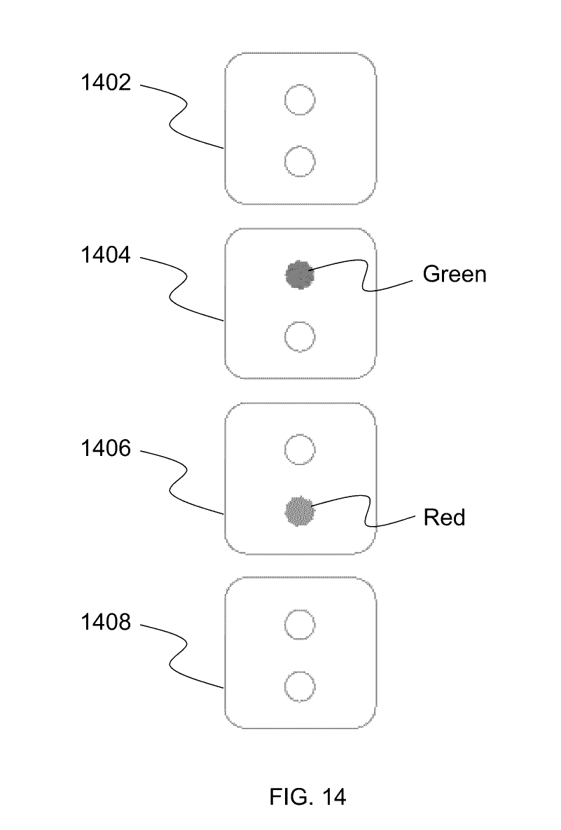

Examples of display patterns may include active blinking for a usable product, no illumination for an expired product, or a message indicated status for either a usable or expired product. FIG. 14 illustrates four examples of display patterns for a two-LED visual indicator system. The top indicator picture 1402 (no LED activity) indicates an inactive TND, while the second indicator picture 1404 (top/green LED blinking) indicates an active, usable TND. The third indicator picture 1406 (bottom/red LED blinking) indicates an expired, unusable item TND, and the fourth indicator picture 1408 (no LED activity) indicates a dead battery on the TND. Although using the identical indication for an inactive and a dead battery may be problematic, it is preferable from a safety perspective that a sticker with an inactive sticker be mistaken for a defective sticker in order to prevent the opposite situation from occurring.

For a passive visual indicator, status may be indicated with illumination or color change. For example, a usable product may glow with a phosphorescent indicator, while an expired product will no longer glow once the phosphorescence has been expended. Color indicators or symbols may indicate usable products, while a change in color may indicate different degrees of usability or expiration.

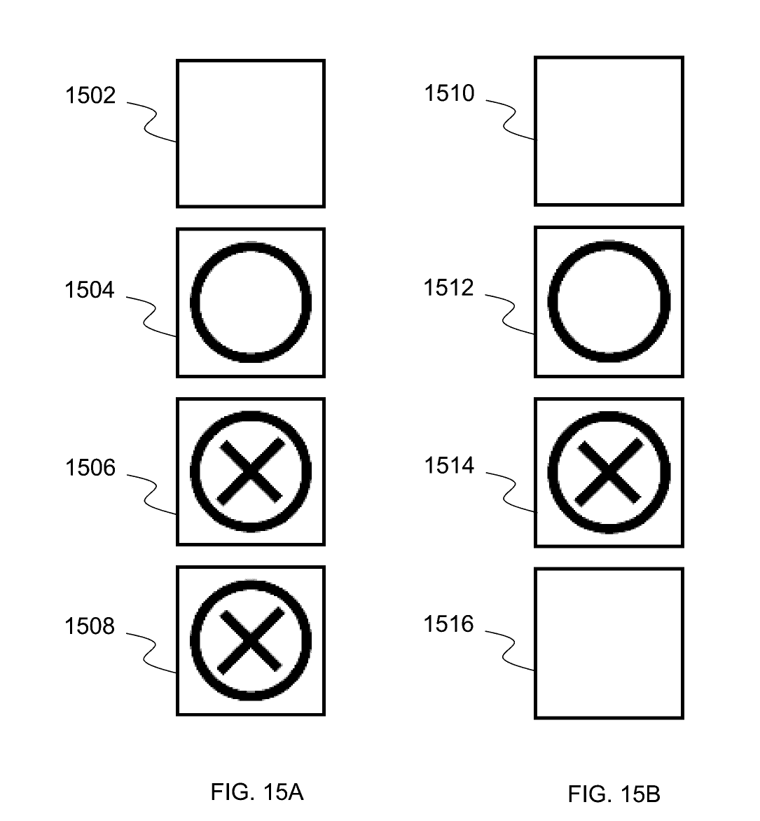

FIG. 15A illustrates a sequence of patterns to be displayed on an e-ink display, with the top (blank) display 1502 representing an inactive sticker, the second (circle symbol) 1504 representing an active sticker, the third (circle with “x” in the middle) 1506 representing an expired sticker, and the fourth (also circle with “x” in the middle) 1508 representing a dead battery. The circle and “x” can be maintained indefinitely upon expiration of the battery.

FIG. 15B illustrates a sequence of patterns to be displayed on an LCD display, with the top (blank) display 1510 representing an inactive sticker, the second (circle symbol) 1512 representing an active sticker, the third (circle with “x” in the middle) 1514 representing an expired sticker, and the fourth (blank) display 1516 representing a dead battery.

Power Source

A variety of power sources may be utilized with the TND to provide power, when needed, to the visual indicator. In one embodiment, a coin cell battery, layered battery or laminated battery may be used. Additionally, a standard capacitor or electrochemical double layer capacitor may be used. Finally, power sources which harvest energy, such as kinetic, thermal, radio frequency or otherwise, may be used. A combination of one or more of these power sources may also be utilized.

In one embodiment, an approximately 3.0-volt lithium coin cell battery may be utilized, when is reduced to 2.5 volts when depleted.

Tracking and Analytics

The TND device may also provide information to allow for tracking and analytics. As has been previously described with reference to FIG. 1, information may be printed on a device surface as it is being dispensed, such as a date stamp 108 and a barcode 106, to allow for secondary, manual tracking of the time intervals.

In another embodiment, additional electronics may be integrated into the sticker, such as location sensors which can sense relative or geographical locations, or wireless transmitters and receivers to transmit usage data via Wi-Fi, Bluetooth, RFID, UWB, NFC, etc. These sensors allow wireless tracking of validity records for inventory management, compliance surveillance, sterilization tracking and other applications through communication with electronic devices such as smartphones, tablets and other computing devices. Software on the electronic devices may provide notifications to a user relating to the status of the TNDs, and the software may be further integrated into an overall safety or risk management software application.

Methods of Use

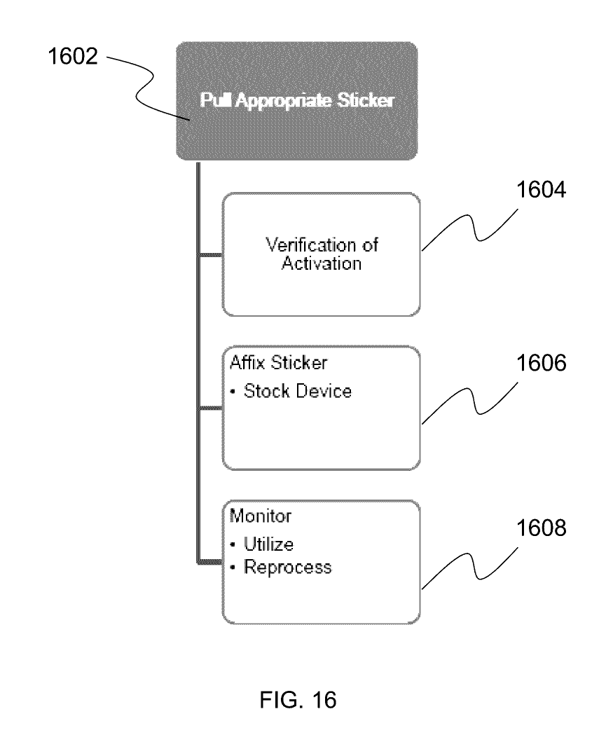

One embodiment of the method for monitoring an item using the TND sticker is illustrated in FIG. 16. In a first step 1602, the sticker is selected and activated, either through the dispenser or manually by the user. Next, the activation of the sticker is verified in step 1604 by checking to see if the visual indicator illuminates in the correct color, pattern or display content. The sticker is then affixed in step 1606 to an item for monitoring, after which the visual indicator is monitored in step 1608 to determine if the item is still valid and usable or expired and in need of reprocessing.

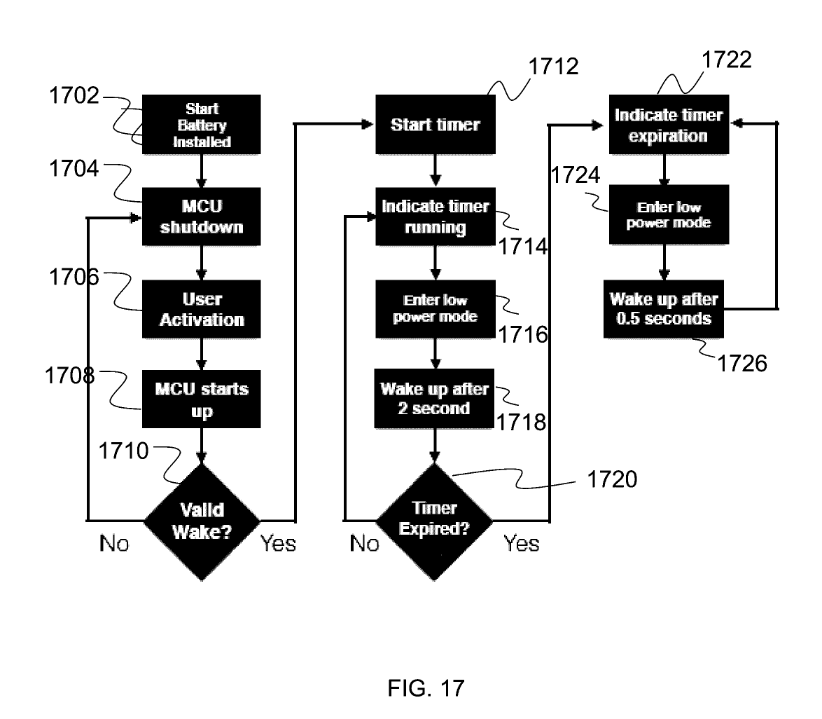

An overall workflow of the activation and monitoring of the electronics of the TND sticker is illustrated in FIG. 17. A battery is first installed (1702), after which the microcontroller (MCU) is shut down (1704) before being activated by the user (1706). The MCU starts back up (1708) and a determination is made as to whether the wake up is valid (1710). If so, the timer is started (1712), and an indication of whether the timer is running is provided (1714). A low power mode is then entered (1716), but the timer will wake up after 2 seconds (1718) to determine if the timer has expired (1720). If not, the timer loop continues to run; if so, a timer expiration indication is given (1722). Another low power mode is entered (1724) and then a wake up occurs after approximately 0.5 seconds (1726).

Computer Embodiment

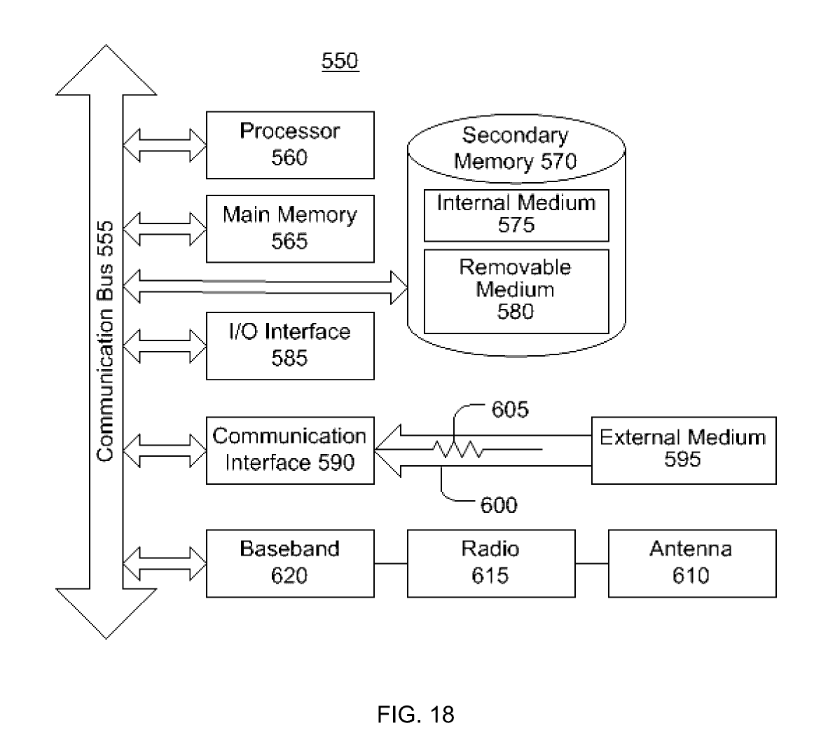

FIG. 18 is a block diagram illustrating an example wired or wireless system 550 that may be used in connection with various embodiments described herein. For example the system 550 may be used as or in conjunction with a time-based visual notification device as previously described with respect to FIGS. 1-17. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like. [99] System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A time-based visual notification device, comprising:
a housing forming at least a top surface and a bottom surface and defining an interior space;
a power source positioned within the interior space;
a visual indicator connected with the power source and positioned within the top surface which displays one or more visual indications;
a controller connected with the power source and the visual indicator which activates the visual indicator to display a first visual indication at a specified time interval of a limited period of time; and
an affixing mechanism attached with a portion of the housing which affixes the time-based visual notification device to an item.

2. The time-based visual notification device of claim 1, wherein the visual indicator displays a second visual indication upon expiration of the limited period of time.

3. The time-based visual notification device of claim 1, wherein the first visual indication and the second visual indication differ in one or more of: a color, a display pattern, a display time, a shape and a symbol.

4. The time-based visual notification device of claim 3, wherein the first visual indication is a first color and the second visual indication is a second color.

5. The time-based visual notification device of claim 4, wherein the limited period of time represents a temporary usability of the item.

6. The time-based visual notification device of claim 5, wherein the temporary usability refers to a cleanliness, sterility, life span or quality of the item.

7. The time-based visual notification device of claim 1, further comprising an activation mechanism which activates the controller to begin measuring the limited period of time and activate the visual indicator at the specified time intervals within the limited period of time.

8. The time-based visual notification device of claim 7, wherein the activation mechanism is a pull-tab which activates the controller when the pull-tab is depressed.

9. The time-based visual notification device of claim 1, wherein the visual indicator is one of: a light emitting diode (LED), a phosphorescent indicator, a chemical indicator, an electrochemical indicator and an electrophoretic indicator.

10. The time-based visual notification device of claim 1, wherein the affixing mechanism is one of: an adhesive, a strap, a magnet and a clip.

11. A method of monitoring a usability of an item, comprising the steps of:
activating a time-based visual notification device to begin measuring a first time interval of a limited period of time;
displaying a first visual indication of the specified time interval during the limited period of time;
affixing the time-based visual notification device to the item; and
displaying a second visual indication at a second specified time interval upon expiration of the limited period of time.

12. The method of claim 11, wherein the first visual indication and the second visual indication differ in one or more of: a color, a display pattern, a display time, a shape and a symbol.

13. The method of claim 11, wherein the first visual indication is a first color and the second visual indication is a second color.

14. The method of claim 11, wherein the limited period of time represents a temporary usability of the item.

15. The method of claim 11, further comprising an activation mechanism which activates the controller to begin measuring the limited period of time and activate the visual indicator at the specified time intervals within the limited period of time.

16. The method of claim 11, further comprising activating the time-based visual notification device by depressing a pull-tab on the time-based visual notification device.

17. A medical device, comprising:
a housing defining an interior space within the medical device;
a power source positioned within the interior space;
a visual indicator which displays one or more visual indications and which is connected with the power source, wherein the visual indicator is positioned within the housing so as to be visible on an exterior surface of the medical device;
a controller connected with the power source and the visual indicator which activates the visual indicator to display a first visual indication at a specified time interval of a limited period of time; and
an activation mechanism located on the exterior surface of the medical device which activates the controller to begin measuring the limited period of time and activate the visual indicator at the specified time intervals within the limited period of time.
